(19) United States
(12) Patent Application Publication
(10) Pub. No.: US 2005/0147106 A1
(43) Pub. Date: Jul. 7, 2005

(54) Transmission system

(76) Inventor: Kazumasa Sonoda, Yokohama (JP)

Correspondence Address: Katten Muchin Zavis Rosenman, 575 Madison Avenue, New York, NY, 10022-2585, US

(21) Appl. No.: 11/034,482

(22) Filed: Jan. 13, 2005

Related U.S. Application Data
(63) Continuation of application No. PCT/JP02/09987, filed on Sep. 26, 2002.

(51) Int. Cl. H04L 12/28

(52) U.S. Cl. 370/395.51

(57) ABSTRACT

A transmission system which can flexibly set/change VC mode and, in case of fault, can reset the VC mode to continue communication. A transmit-side VC mode setting unit sets a VC mode according to upper-level setting or path fault information. A transmit-side signal control unit controls signals in the VC mode. A path monitoring/setting unit generates a specific pattern. A first signal transmitting/receiving unit transmits the VC mode and the specific pattern to a remote device, and receives path fault information from the remote device. A second signal transmitting/receiving unit detects the VC mode and the specific pattern and transmits path fault information to the remote device. A receive-side VC mode setting unit sets the received VC mode. A receive-side signal control unit controls signals in the VC mode. Based on the specific pattern, a path monitoring/determination unit generates the path fault information indicative of a path connection determination result.

### CROSS-REFERENCE TO RELATED APPLICATIONS

This application is a continuing application, filed under 35 U.S.C. § 111(a), of International Application PCT/JP2002/009987, filed Sep. 26, 2002.

### BACKGROUND OF THE INVENTION

(1) Field of the Invention

The present invention relates to a transmission system, and more particularly, to a transmission system for carrying out transmission control for VC (Virtual Concatenation) in which bandwidth is handled as a set of virtual signal units.

(2) Description of the Related Art

SONET (Synchronous Optical Network)/SDH (Synchronous Digital Hierarchy), which is a core technology of multiplexing technologies, defines interfaces for efficiently multiplexing various communication services. The SONET/SDH technology is currently standardized and still on the way to development.

Paths used in SONET networks are usually in the units STS (Synchronous Transport Signal)-1, STS-3c, STS-12c, STS-48c, etc. whose bandwidths are 51.84 Mbps, 155.52 Mbps, 622.08 Mbps, 2.48832 Gbps, etc., respectively.

The suffix “c” in STS-3c, STS-12c, etc. represents concatenation, and STS-3c and STS-12c have threefold and twelvefold capacities, respectively, of the basic STS-1 path. The SONET standard defines the types of concatenation as 3/12/1948/192.

Let us now consider the case where a transmission node in a SONET network is connected to an Ethernet (registered trademark) network. Ethernet provides physical communication bandwidths of 100 Mbps, 1 Gbps, etc., and these bit rates are used during the highest-rate transmission. An actual communication bandwidth, however, depends on the bandwidth used by users, and in the case of transmitting Ethernet signal over a SONET network, it is not necessary that a maximum bandwidth be allocated to the path in the SONET network.

Namely, where 50 Mbps communication is to be performed using a 100 Mbps Ethernet unit, an STS-1 path may be set. Also, in the case of performing 100 Mbps communication by using a 1 Gbps Ethernet unit, an STS-3c path may be set.

If an STS-12c path is used in the case where 200 Mbps communication is performed using a 1 Gbps Ethernet unit, a bandwidth of about 400 Mbps is wasted because STS-12c has a bandwidth of 622.08 Mbps. As a measure to avoid such waste, a technique called virtual concatenation (VC) is recently attracting attention whereby a path with a bandwidth as close to the required bandwidth as possible can be secured.

VC is a technique of making efficient use of transmission bandwidth, wherein a desired number of STS-1 or STS-3 paths are bundled together and handled as a single virtual path, thereby varying the bandwidth as needed.

For 200 Mbps communication mentioned in the above instance, four STS-1 paths may be bundled to create an STS-1-4v path (“v” in STS-1-4v represents VC) with a bandwidth of 207.36 Mbps for communication, thereby eliminating waste of bandwidth in the SONET network.

The SONET/SDH transmission technology has been actively researched and developed, and there has been proposed a system wherein concatenation is discriminated in a repeater on the basis of the overhead of the received signal, to set concatenation anew. For example, refer to Unexamined Japanese Patent Publication No. H05-336066 (paragraph nos. [0020] to [0023], FIG. 1).

In conventional VC path setting, it is necessary not only to set a SONET path between terminating points of the path, but also to make settings so as to have the opposite path terminating units aware of the VC path. Namely, when setting VC, manual setting must be carried out with respect to each of the devices of transmitting and receiving sides. Consequently, the VC operation mode setting is not easy, giving rise to a problem that the VC operation mode cannot be flexibly changed.

Also, a VC path is constituted by a plurality of STS paths to realize communication, but in conventional systems, if any of the paths constituting the VC path develops anomaly (fault), the communication itself becomes unavailable, posing a problem of low reliability.

### SUMMARY OF THE INVENTION

The present invention was created in view of the above circumstances, and an object thereof is to provide a transmission system which is capable of flexibly setting and changing the VC operation mode and, in case of fault, can reset the VC mode to continue communication, thereby improving the quality and reliability of communication.

To achieve the object, there is provided a transmission system for carrying out transmission control for VC in which bandwidth is handled as a set of virtual signal units. The transmission system comprises a VC transmitting device and a VC receiving device. The VC transmitting device includes a transmit-side VC mode setting unit for setting a VC mode of the VC transmitting device in accordance with one of upper-level setting and path fault information, a transmit-side signal control unit for controlling signals of the VC transmitting device in the VC mode, a path monitoring/setting unit for generating a specific pattern for monitoring path connection, and a first signal transmitting/receiving unit for transmitting, to an associated remote device, a signal in which the set VC mode and the specific pattern are inserted, and receiving the path fault information from the remote device. The VC receiving device includes a second signal transmitting/receiving unit for detecting the VC mode and the specific pattern from the received signal and transmitting, to the associated remote device, a signal in which generated path fault information is inserted, a receive-side VC mode setting unit for setting a VC mode of the VC receiving device in accordance with the detected VC mode, a receive-side signal control unit for controlling signals of the VC receiving device in the VC mode, and a path monitoring/determination unit for determining based on the received specific pattern whether the path connection is normal or not, and generating the path fault information indicative of a determination result.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 illustrates the principle of a transmission system according to the present invention.

FIG. 2 shows an entire configuration of the transmission system.

FIG. 3 shows a configuration of an Ethernet interface (INF) unit.

FIG. 4 is a sequence diagram illustrating operation of setting a VC mode in devices when there is no path fault.

FIG. 5 is a sequence diagram also illustrating the operation of setting the VC mode in the devices when there is no path fault.

FIG. 6 is a sequence diagram illustrating operation of resetting the VC mode of the devices when there has occurred a path fault.

FIG. 7 is a sequence diagram also illustrating the operation of resetting the VC mode of the devices when there has occurred a path fault.

FIG. 8 is a sequence diagram also illustrating the operation of resetting the VC mode of the devices when there has occurred a path fault.

FIG. 9 illustrates occurrence of a path fault.

FIG. 10 shows an STS-1 format.

FIG. 11 shows an STS-3c format.

FIG. 12 shows a POH arrangement.

FIG. 13 illustrates H4 byte coding.

FIG. 14 is a conceptual diagram showing the flow of the VC mode and path fault information during normal transmission.

FIG. 15 is a conceptual diagram showing the flow of a newly set VC mode and path fault information after the occurrence of a path fault during transmission.

### DESCRIPTION OF THE PREFERRED EMBODIMENTS

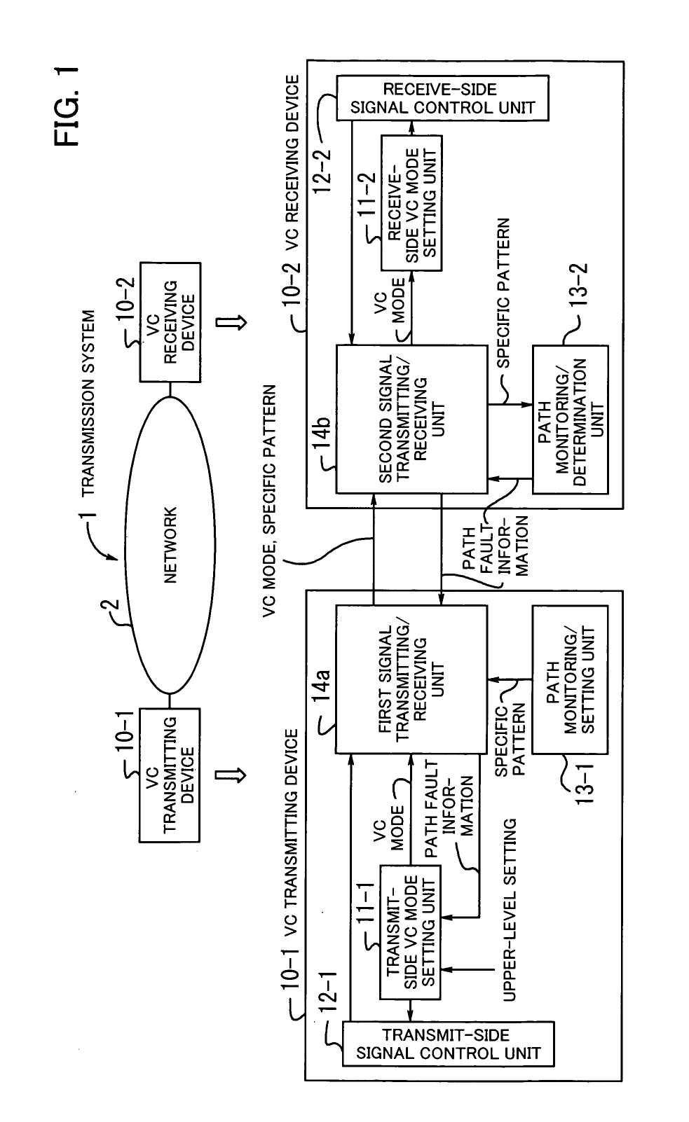

Preferred embodiments of the present invention will be described below with reference to the accompanying drawings. FIG. 1 illustrates the principle of a transmission system according to the present invention. The transmission system 1 comprises a VC transmitting device 10-1 and a VC receiving device 10-2 and carries out transmission control, over a network 2, for VC (Virtual Concatenation) in which bandwidth is handled as a set of virtual signal units (STS-1, STS-3c, etc.). In practice, the functions of the present invention performed by the VC transmitting and receiving devices 10-1 and 10-2 are incorporated into a single transmission device.

The VC transmitting device 10-1 includes a transmit-side VC mode setting unit 11-1, a transmit-side signal control unit 12-1, a path monitoring/setting unit 13-1, and a first signal transmitting/receiving unit 14a.

The transmit-side VC mode setting unit 11-1 sets a VC mode of the VC transmitting device 10-1 in accordance with upper-level setting or path fault information. The VC mode is VC operation mode information indicating which VC, for example, STS-1-4v or STS-1-24v, is to be used for transmitting data.

The transmit-side signal control unit 12-1 controls signals of the VC transmitting device 10-1 in the VC mode. For example, if STS-1-4v has been set as the VC mode, the control unit 12-1 controls signals according to a transmission rate of 207.36 Mbps.

The path monitoring/setting unit 13-1 generates a specific pattern for monitoring path connection. In practice, a plurality of specific patterns equal to the number of channels constituting a VC path are generated. For example, in the case of an STS-1-4v path constituted by four channels, four specific patterns corresponding to the respective channels are generated.

The first signal transmitting/receiving unit 14a transmits, to an associated remote device, a signal in which the set VC mode and the specific pattern are inserted, and also receives path fault information from the remote device.

The VC receiving device 10-2 includes a second signal transmitting/receiving unit 14b, a receive-side VC mode setting unit 11-2, a receive-side signal control unit 12-2, and a path monitoring/determination unit 13-2.

The second signal transmitting/receiving unit 14b detects the VC mode and the specific pattern from the received signal and also transmits, to the remote device, a signal in which is inserted path fault information generated by the path monitoring/determination unit 13-2.

The receive-side VC mode setting unit 11-2 sets the VC mode of the VC receiving device 10-2 in accordance with the detected VC mode. The receive-side signal control unit 12-2 controls signals of the VC receiving device 10-2 in the VC mode. If the detected VC mode is STS-1-4v, for example, the control unit 12-2 controls signals according to a transmission rate of 207.36 Mbps.

The path monitoring/determination unit 13-2 determines based on the received specific pattern whether the path connection is normal or not, and generates path fault information indicative of the determination result. The path monitoring/determination unit 13-2 judges that a substantial path fault has occurred if an error in the specific pattern is continuously detected for over a preset number of consecutive frames.

Control flow during normal path connection will be now described. In the VC transmitting device 10-1, the transmit-side VC mode setting unit 11-1 sets a VC mode (e.g., STS-1-4v). Thereupon, the path monitoring/setting unit 13-1 generates specific patterns for monitoring the STS-1-4v path, and the first signal transmitting/receiving unit 14a transmits the VC mode and the specific patterns.

The path monitoring/determination unit 13-2 judges that the received specific patterns are normal. Accordingly, the unit 13-2 generates path fault information indicating normalcy of the path, and the second signal transmitting/receiving unit 14b transmits the generated path fault information. Also, the receive-side VC mode setting unit 11-2 detects the VC mode transmitted from the VC transmitting device 10-1, and the VC receiving device 10-2 processes the signal in accordance with the detected VC mode.

In this manner, the VC transmitting device 10-1 transmits information about the VC mode set thereby, and the VC receiving device 10-2 detects the set VC mode, whereby the VC mode set at the transmitting side can be automatically set at the receiving side in such a manner that the VC mode of the receiving side follows that of the transmitting side.

The following describes control flow during the occurrence of a path fault. In the VC transmitting device 10-1, the transmit-side VC mode setting unit 11-1 sets a VC mode (e.g., STS-1-4v). The path monitoring/setting unit 13-1 generates specific patterns for monitoring the STS-1-4v path, and the first signal transmitting/receiving unit 14a transmits the VC mode and the specific patterns.

The path monitoring/determination unit 13-2 receives the specific patterns. It is assumed here that among the received specific patterns, a specific pattern corresponding to a channel ch4 is anomalous (the received pattern is different (in bit value) from the transmitted pattern). Thus, the path monitoring/determination unit 13-2 generates path fault information indicative of the ch4 fault.

The second signal transmitting/receiving unit 14b transmits the path fault information, and based on the received path fault information, the transmit-side VC mode setting unit 11-1 changes the VC mode from STS-1-4v to STS-1-3v. Also, a notification of the VC mode thus changed is transmitted from the first signal transmitting/receiving unit 14a to the VC receiving device 10-2.

Thus, in the event a path fault occurs, path fault information indicating which channel is anomalous is transmitted to the transmitting side, and a new VC mode excluding the faulty channel is again set in the VC transmitting and receiving devices 10-1 and 10-2 (the VC mode of the receiving side follows that reset at the transmitting side), whereby communication can be continued even in the case where a path fault has occurred (in the above instance, however, the transmission capacity decreases from 207.36 Mb/s to 155.52 Mb/s).

Referring now to the case where the present invention is applied to a transmission node interconnecting an Ethernet network as a subscriber-side network (LAN) and a SONET network as a backbone network, the construction and operation of the node will be described in detail.

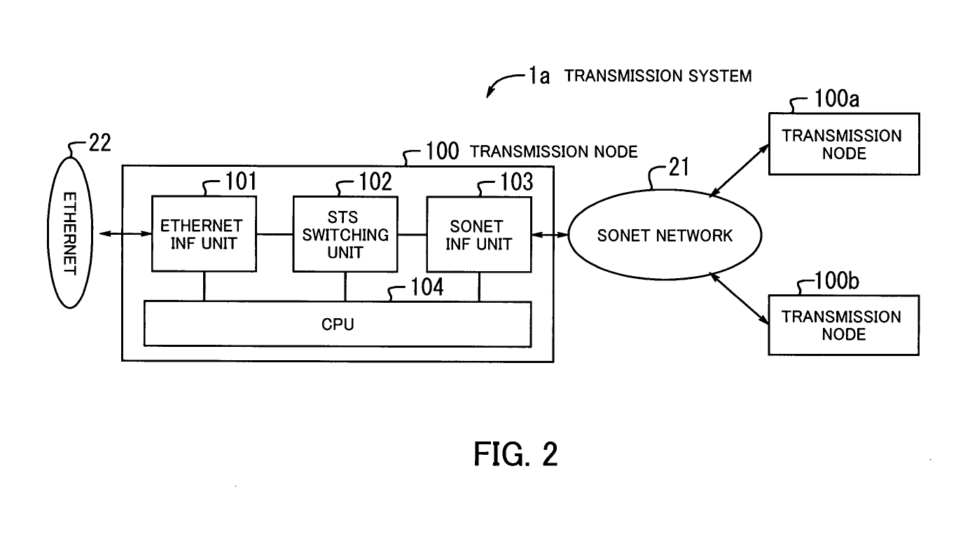

FIG. 2 shows an entire configuration of the transmission system. The transmission system 1a includes transmission nodes 100, 100a and 100b connected at path terminating points of a SONET network 21. The transmission node 100 comprises an Ethernet interface (INF) unit 101, an STS switching unit 102, a SONET interface (INF) unit 103, and a CPU 104.

The Ethernet interface unit 101 has the function of the transmission device according to the present invention, and converts packets conformable to an Ethernet network 22 into a time-division STS signal conformable to the SONET network 21 and vice versa.

The STS switching unit 102 performs switching of the STS signal (cross-connect: concentration/separation of lines). The SONET interface unit 103 controls interfacing with the SONET network 21. The CPU 104 globally controls the elements in the node.

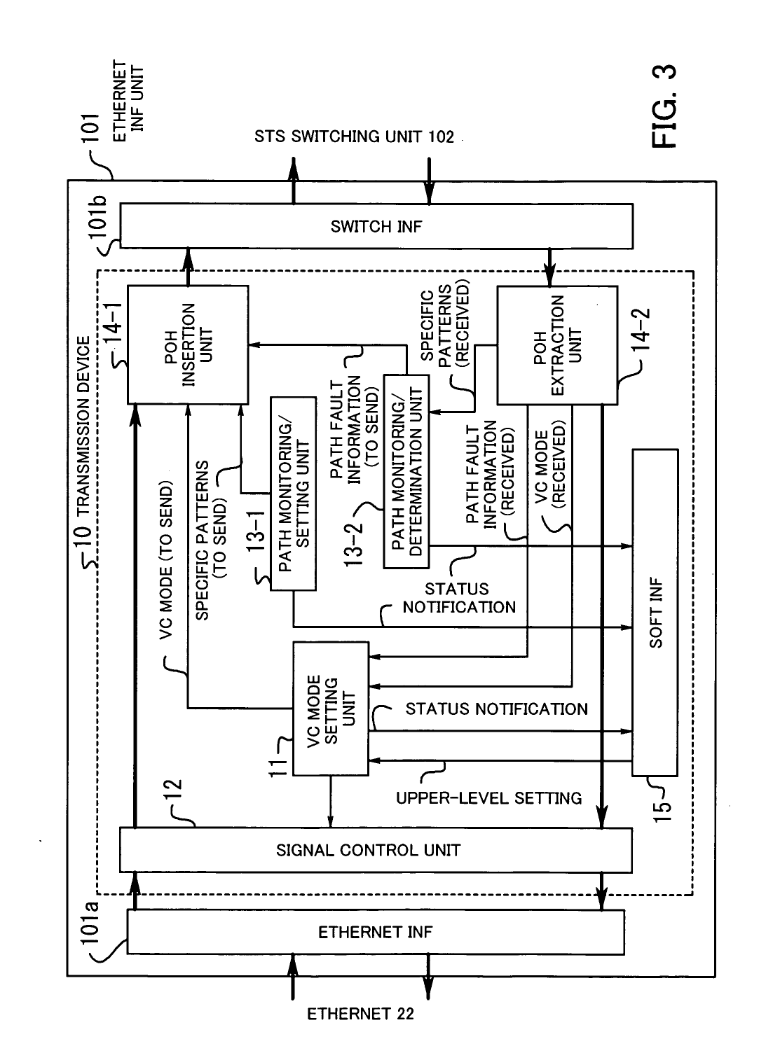

FIG. 3 shows the configuration of the Ethernet interface unit 101. The Ethernet interface unit 101 comprises an Ethernet interface 101a, the transmission device 10, and a switch interface 101b. In the figure, each thick solid line with an arrowhead indicates a main signal, and each thin solid line with an arrowhead indicates a control signal.

The Ethernet interface 101a controls interfacing with the Ethernet network. For example, the interface 101a performs processing associated with layer-2 PPP (Point-to-Point Protocol) as well as MAC (Media Access Control). The switch interface 101b controls interfacing with the STS switching unit 102.

The transmission device 10 comprises a VC mode setting unit 11, a signal control unit 12, the path monitoring/setting unit 13-1, the path monitoring/determination unit 13-2, a POH (Path OverHead) insertion unit 14-1, a POH extraction unit 14-2, and a soft interface (INF) 15.

The VC mode setting unit 11 (corresponding to the transmit-side VC mode setting unit 11-1 and the receive-side VC mode setting unit 11-2 appearing in FIG. 1) sets the VC mode in accordance with upper-level setting or path fault information when operating as a VC mode setting side to transmit the set VC mode. Also, when operating as a VC mode set side to receive the VC mode, the VC mode setting unit 11 sets the same VC mode as that detected from the received signal.

The signal control unit 12 (corresponding to the transmit-side signal control unit 12-1 and the receive-side signal control unit 12-2 appearing in FIG. 1) controls the signal (STS signal) in the VC mode set by the VC mode setting unit 11. Specifically, the control unit 12 controls the process associated with the payloads of the STS signal (in the case of STS-1-4v, for example, a time adjustment process for adjusting the heads of payloads since the transmission routes of the four paths are not always the same) as well as the VC frame numbering process.

The path monitoring/setting unit 13-1 and the path monitoring/determination unit 13-2 are already explained above with reference to FIG. 1, and therefore, description thereof is omitted. The POH insertion unit 14-1 as a signal transmitting unit inserts the VC mode, specific patterns and path fault information in the POH of the STS signal, which is then transmitted to an associated remote node. The POH extraction unit 14-2 extracts the POH from the received STS signal and detects the VC mode, specific patterns and path fault information inserted therein.

When the transmission device 10 is operating as the VC transmitting device 10-1 shown in FIG. 1, the POH insertion unit 14-1 and the POH extraction unit 14-2 function as the first signal transmitting/receiving unit 14a. On the other hand, when the transmission device 10 is operating as the VC receiving device 10-2 shown in FIG. 1, the POH insertion unit 14-1 and the POH extraction unit 14-2 function as the second signal transmitting/receiving unit 14b.

The soft interface 15 controls interfacing with the CPU 104 (FIG. 2). Specifically, the interface 15 sends status notifications, received from the individual elements in the transmission device 10, to the CPU 104 and also supplies instructions from the CPU 104 to the respective elements of the transmission device 10.

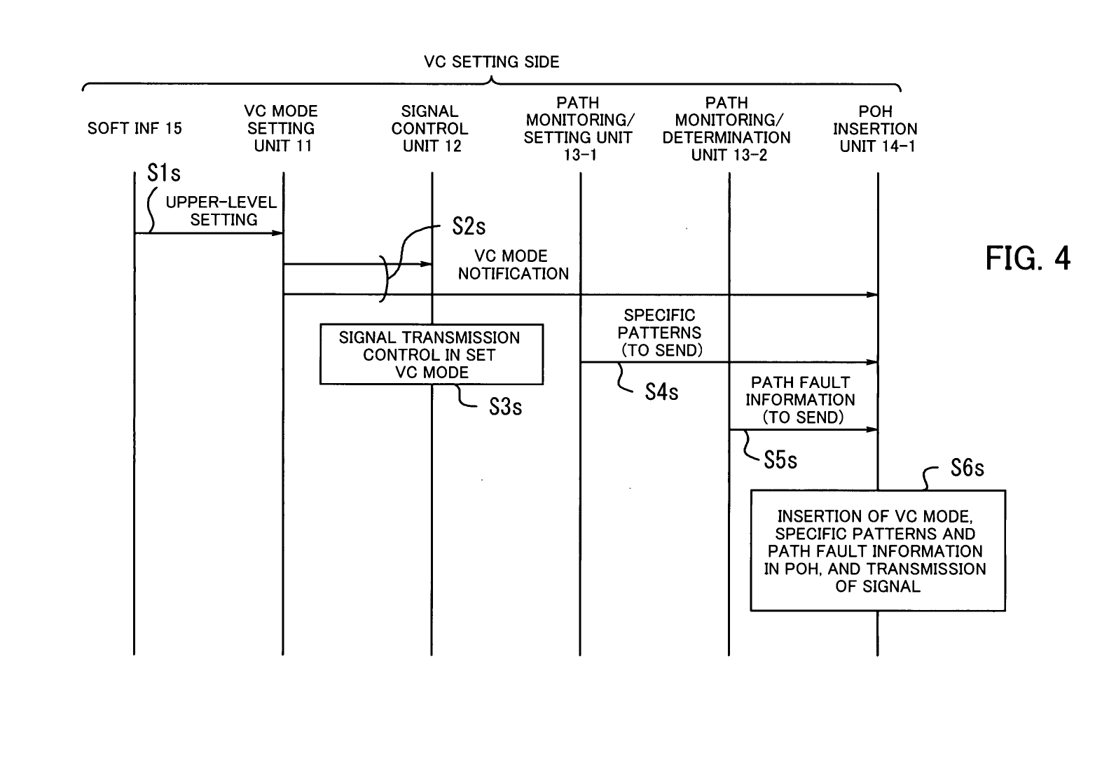

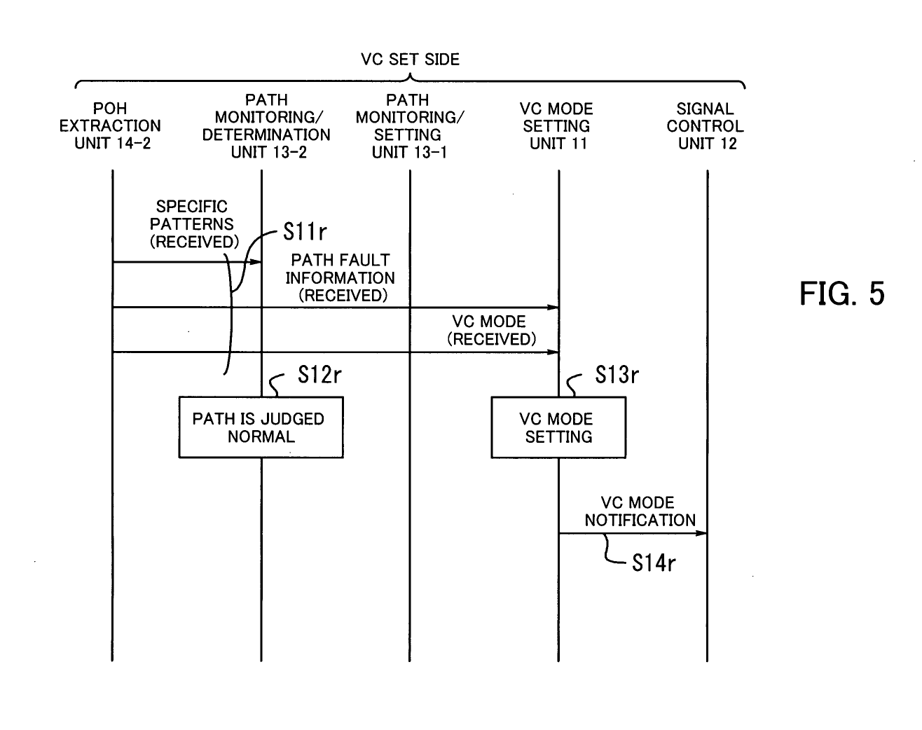

Operation of the transmission device 10 will be now described. FIGS. 4 and 5 are sequence diagrams illustrating the operation of setting the VC mode in the devices when there is no path fault. Steps S1s to S6s in FIG. 4 show an operation sequence of the transmission device 10 acting as a VC setting side (transmitting side), and Steps S11r to S14r in FIG. 5 show an operation sequence of the transmission device 10 acting as a VC set side (receiving side). Also, in the figures, the VC mode setting is triggered by upper-level setting.

The “VC setting side” denotes a device which sets VC earlier, and the “VC set side” denotes a device which a sets VC later following the VC setting at the VC setting side.

[S1s] On receiving an instruction from the CPU 104, the soft interface 15 sends, to the VC mode setting unit 11, an instruction to set a VC mode (in this instance, STS-1-24v is set).

[S2s] The VC mode setting unit 11 sets STS-1-24v as an internal operation mode and then notifies the signal control unit 12 and the POH insertion unit 14-1 of the contents of the settings.

[S3s] The signal control unit 12 controls signal transmission according to STS-1-24v (about 1.2 Gb/s).

[S4s] The path monitoring/setting unit 13-1 sends specific patterns to the POH insertion unit 14-1. As the specific patterns, hexadecimal “AA” is set for all the 24 channels, for example.

[S5s] The path monitoring/determination unit 13-2 sends path fault information to the POH insertion unit 14-1. In the current state, there is no path fault occurring, and accordingly, the path fault information indicates that the 24 channels are all normal.

[S6s] The POH insertion unit 14-1 inserts the set VC mode and the path fault information from the path monitoring/determination unit 13-2 into H4 byte of the POH, also inserts the specific patterns from the path monitoring/setting unit 13-1 into C2 byte of the POH, and transmits the resultant STS signal to the remote device. The signal formats will be described in detail later.

[S11r] Referring now to FIG. 5, the POH extraction unit 14-2 extracts the POH from the received STS signal, detects the VC mode, specific patterns and path fault information inserted therein, and outputs the detected data items to respective destinations.

[S12r] Since there is no path fault occurring, the path monitoring/determination unit 13-2 detects “AA” for each specific pattern and judges that the path connection is normal.

[S13r] The VC mode setting unit 11 judges from the received path fault information that all the 24 channels are normal, and thus sets the received VC mode (STS-1-24v) as the device operation mode.

[S14r] The VC mode setting unit 11 notifies the signal control unit 12 of STS-1-24v as the set VC mode. The signal control unit 12 thereafter controls signal transmission according to STS-1-24v. Thus, following the VC mode setting at the VC setting side, the VC set side automatically sets the VC mode therein.

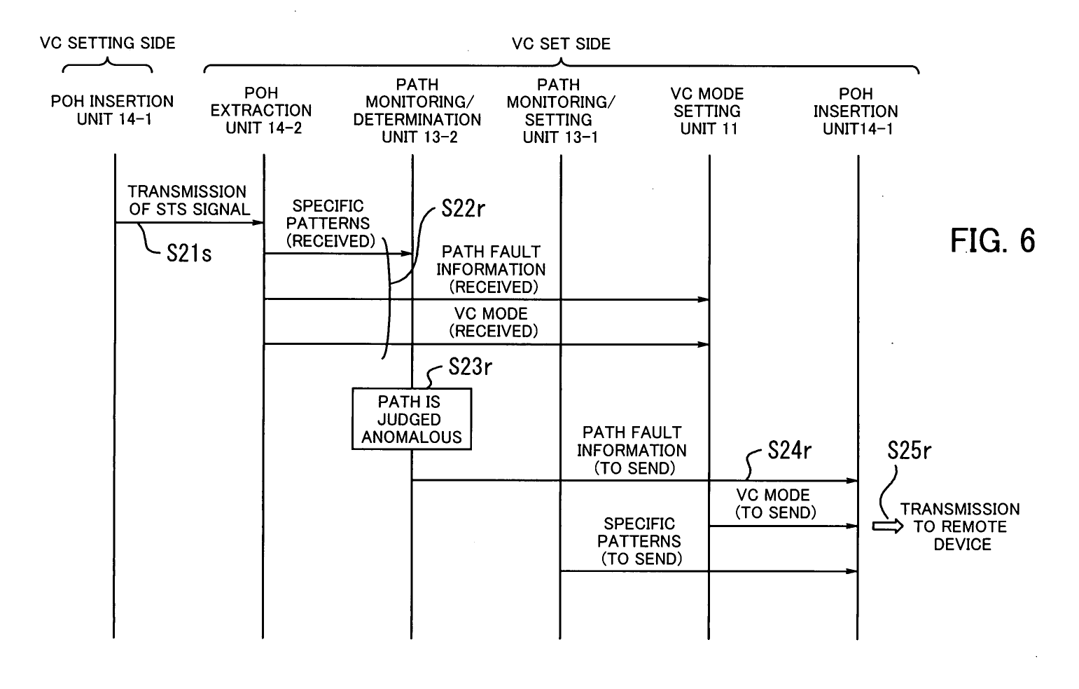

FIGS. 6 to 8 are sequence diagrams illustrating the operation of resetting the VC mode of the devices in the case where a path fault has occurred. Step S21s in FIG. 6 shows an operation of the transmission device 10 acting as the VC setting side, and Steps S22r to S25r show an operation sequence of the transmission device 10 acting as the VC set side.

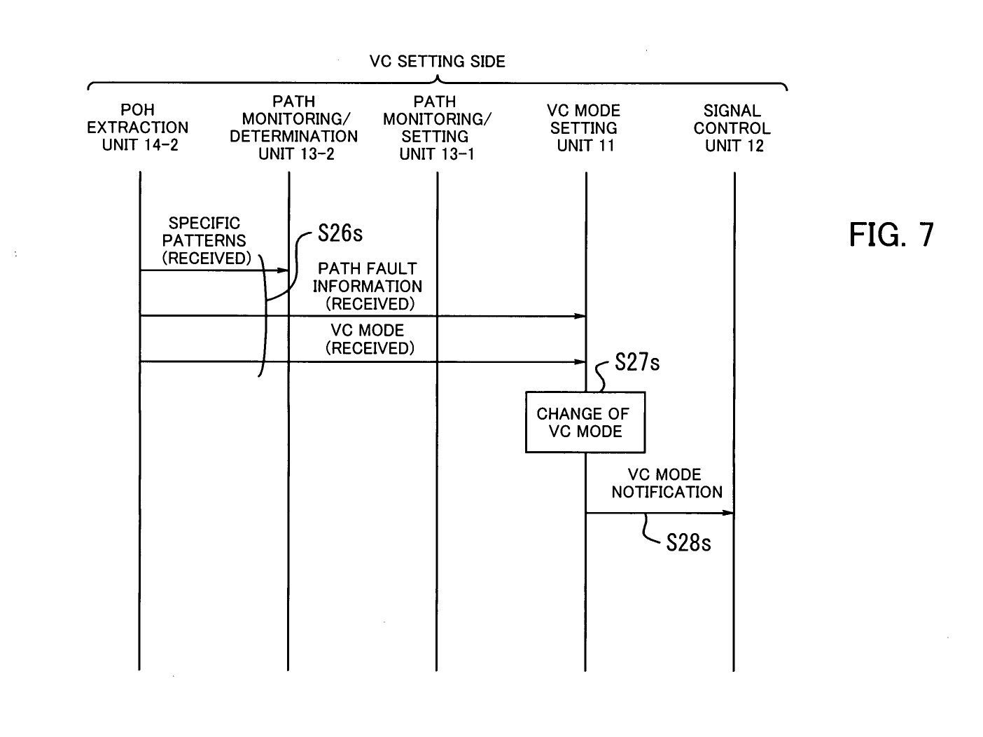

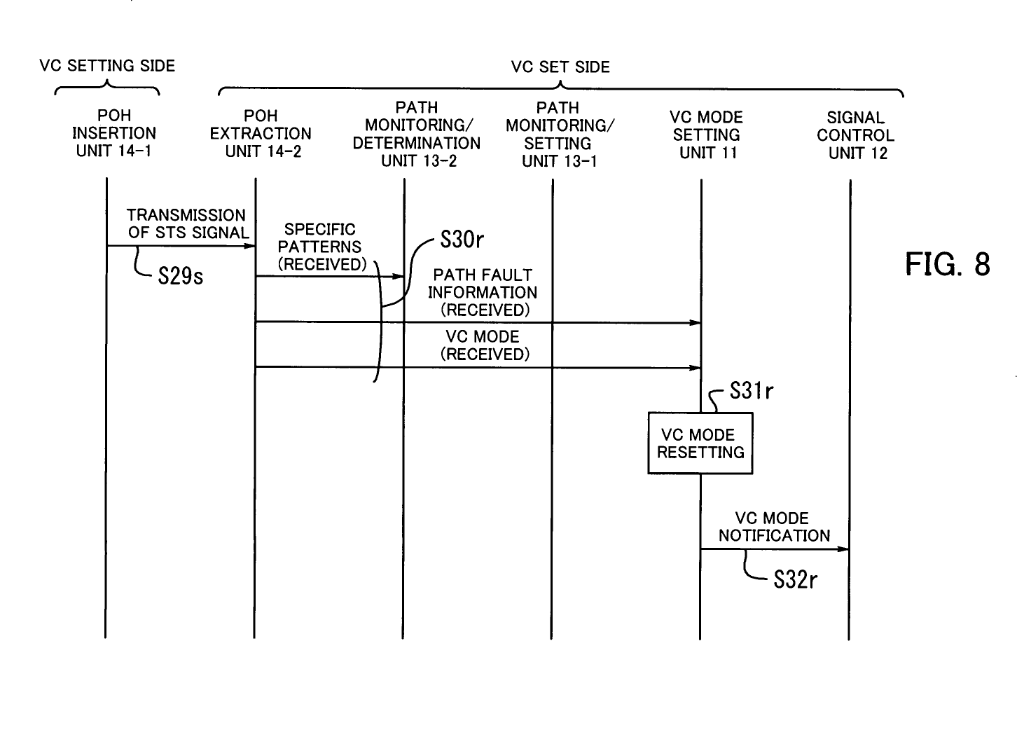

Also, Steps S26s to S28s in FIG. 7 show an operation sequence of the transmission device 10 acting as the VC setting side. Step S29s in FIG. 8 shows an operation of the transmission device 10 acting as the VC setting side, and Steps S30r to S32r show an operation sequence of the transmission device 10 acting as the VC set side. The following explains the case where a path fault occurs during the signal transmission according to STS-1-24v and the VC mode of the devices is thereafter changed and reset.

[S21s] The POH insertion unit 14-1 inserts the VC mode (STS-1-24v) and the path fault information (at this point of time, information indicating normalcy of the path) from the path monitoring/determination unit 13-2 into H4 byte of the POH, also inserts the specific patterns (“AA” is set for the 24 channels) from the path monitoring/setting unit 13-1 into C2 byte of the POH, and transmits the resultant STS signal to the remote device.

[S22r] The POH extraction unit 14-2 extracts the POH from the received STS signal, detects the VC mode, specific patterns and path fault information inserted therein, and outputs the detected data items to the respective destinations. It is assumed here that during the transmission, a path fault has occurred in the channel ch1, among ch1 through ch24.

[S23r] The path monitoring/determination unit 13-2 detects “AA” for the specific patterns associated with ch2 to ch24 but a pattern different from “AA” (e.g., “A9”) with respect to ch1, and thus judges that the transmission via ch1 is anomalous.

[S24r] The path monitoring/determination unit 13-2 generates path fault information indicative of the occurrence of the fault in ch1, and sends the generated information to the POH insertion unit 14-1.

[S25r] The POH insertion unit 14-1 inserts the VC mode (at this point of time, STS-1-24v) and the path fault information (indicative of the occurrence of the fault in ch1) from the path monitoring/determination unit 13-2 into H4 byte of the POH, also inserts the specific patterns (“AA” is set for the 24 channels) from the path monitoring/setting unit 13-1 into C2 byte of the POH, and transmits the resultant STS signal to the remote device. Since the specific patterns (to send) are set in the VC set side, the values thereof remain at “AA.”

[S26s] Referring now to FIG. 7, the POH extraction unit 14-2 extracts the POH from the received STS signal, detects the VC mode, specific patterns and path fault information inserted therein, and outputs the detected data items to the respective destinations.

[S27s] The VC mode setting unit 11 judges from the received path fault information that ch1, among ch1 through ch24, is anomalous, and changes the VC mode from STS-1-24v to STS-1-23v. Then, the unit 11 sets STS-1-23v as the device operation mode.

[S28s] The VC mode setting unit 11 notifies the signal control unit 12 of STS-1-23v as the set VC mode, and the signal control unit 12 thereafter controls signal transmission according to STS-1-23v.

[S29s] Referring now to FIG. 8, the POH insertion unit 14-1 inserts the VC mode (newly set STS-1-23v) and the path fault information (indicative of the occurrence of the fault in ch1) from the path monitoring/determination unit 13-2 into H4 byte of the POH, also inserts the specific patterns (“AA” is set for the 24 channels) from the path monitoring/setting unit 13-1 into C2 byte of the POH, and transmits the resultant STS signal to the remote device.

[S30r] The POH extraction unit 14-2 extracts the POH from the received STS signal, detects the VC mode, specific patterns and path fault information inserted therein, and outputs the detected data items to the respective destinations.

[S31r] The VC mode setting unit 11 judges from the received path fault information that ch1, among ch1 through ch24, is anomalous, and then sets the received VC mode (STS-1-23v) as the device operation mode.

[S32r] The VC mode setting unit 11 notifies the signal control unit 12 of STS-1-23v as the set VC mode, and the signal control unit 12 thereafter controls signal transmission according to STS-1-23v. Thus, in cases where a path fault has occurred, the VC mode is suitably changed and the VC mode of the VC set side is automatically reset following the VC mode resetting of the VC setting side.

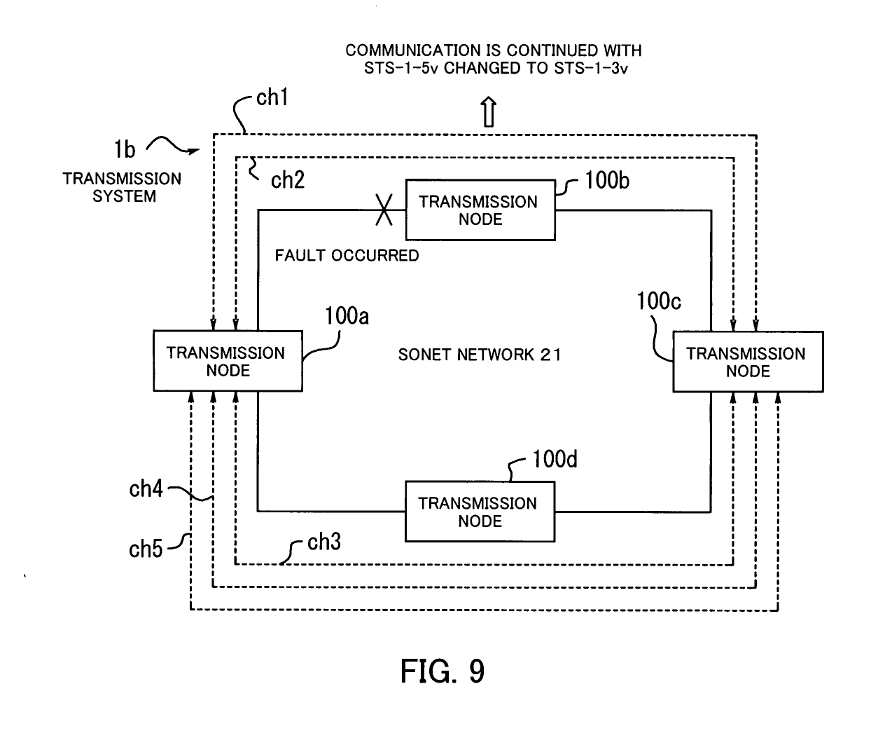

FIG. 9 illustrates signal transmission in case of a path fault. A transmission system 1b is constituted by transmission nodes 100a to 100d connected in the form of a ring within the SONET network 21.

The figure illustrates the case where while VC signal transmission according to STS-1-5v is performed between the transmission nodes 100a and 100c (ch1 and ch2 via the transmission node 10b, and ch3 to ch5 via the transmission node 100d), the optical fiber cable between the transmission nodes 100a and 100b is disconnected, causing a path fault in ch1 and ch2.

According to the conventional VC transmission, if any of the channels constituting the VC path becomes anomalous as in the above case, the communication itself becomes unavailable. By contrast, according to the present invention, the VC mode of the transmission nodes 100a and 100c can be changed to STS-1-3v, thereby enabling the communication to continue via ch3 to ch5 (at a lower transmission rate).

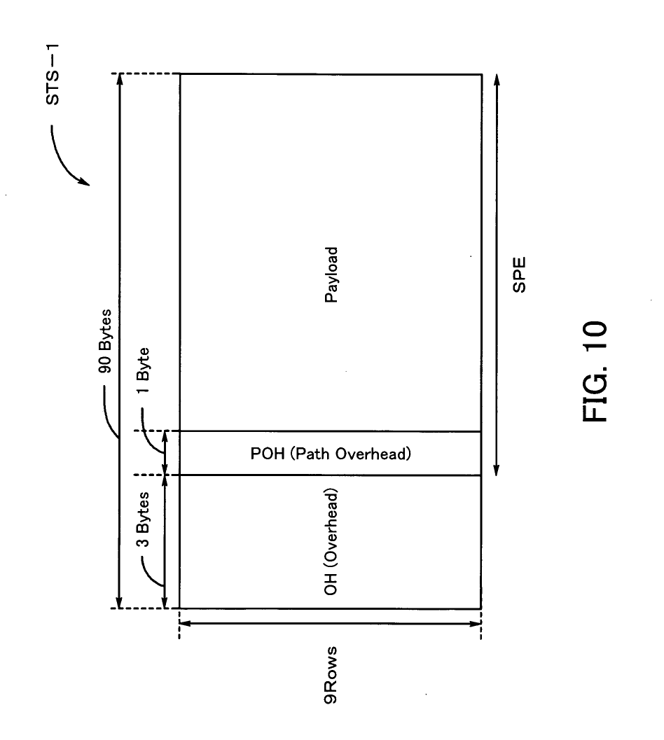

STS signal formats will be now explained. As shown in FIG. 10, the format of an STS-1 frame consists of 9 rows by 90 columns (bytes). The 3 byte area on the left side of the figure is reserved for OH (overhead), and the remaining 87 byte area except the POH, on the right side of the figure, is reserved for payload which carries actual user data. The POH and the payload together are called synchronous payload envelope (SPE).

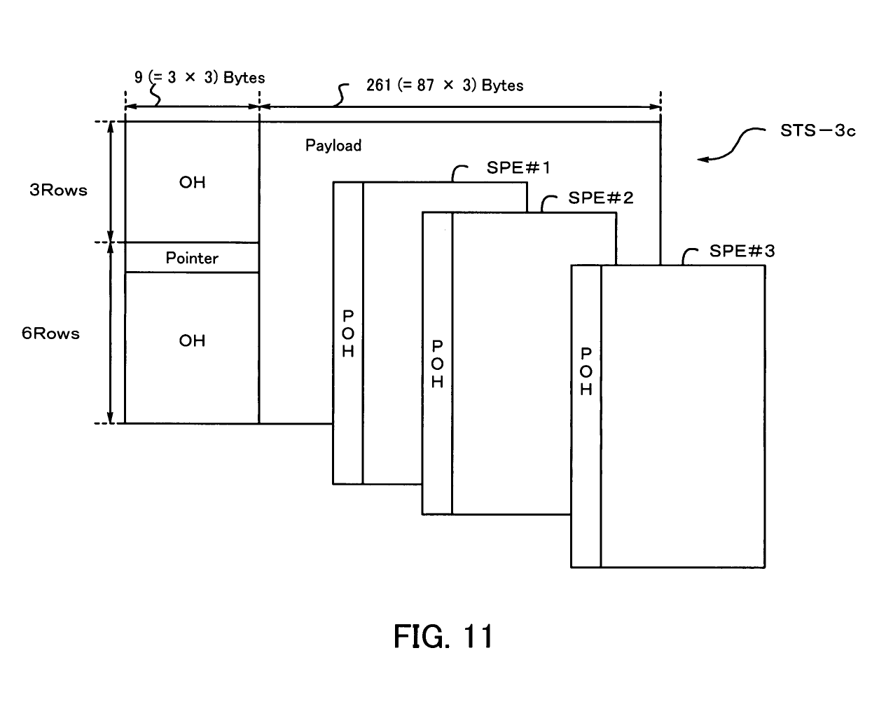

FIG. 11 shows an STS-3c format. An STS-3c frame is depicted as a two-dimensional byte arrangement of 9 rows by 270 columns. The beginning area of 9 rows by 9 (=3×3) columns is used for the OH, and the succeeding area of 9 rows by 261 (=87×3) columns is the payload for carrying multiplexed information. In the payload of an STS-3c frame are multiplexed SPEs (SPE#1, SPE#2, SPE#3) each corresponding to an STS-1 frame except the OH, explained above with reference to FIG. 10.

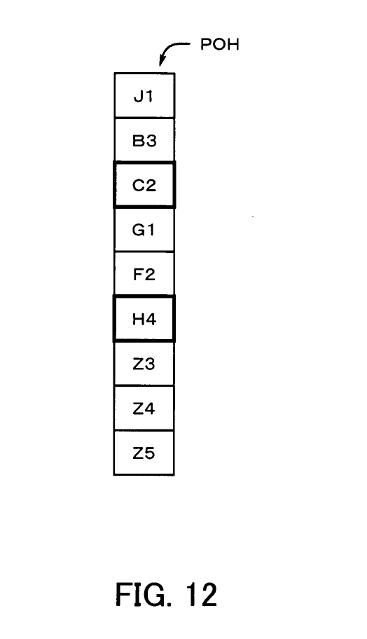

FIG. 12 shows the arrangement of the POH. The POH consists of J1 byte, B3 byte, C2 byte, G1 byte, F2 byte, H4 byte, Z3 byte, Z4 byte, and Z5 byte. According to the present invention, C2 byte is used for the specific patterns, and H4 byte is used for the VC mode (4 bits) and the path fault information (4 bits).

In accordance with the Telcordia recommendations (concerning the use on GR-253-CORE), for example, the other bytes are used as follows: J1 is used for path trace, B3 is used for path error monitoring, b1 to b4 of G1 are used for remote path error indication, b5 of G1 is used for the transfer of transmitting path status, b6 to b8 of G1 are unused, F2 is used for path unit channel, Z3 and Z4 are reserved, and Z5 is used for tandem connection.

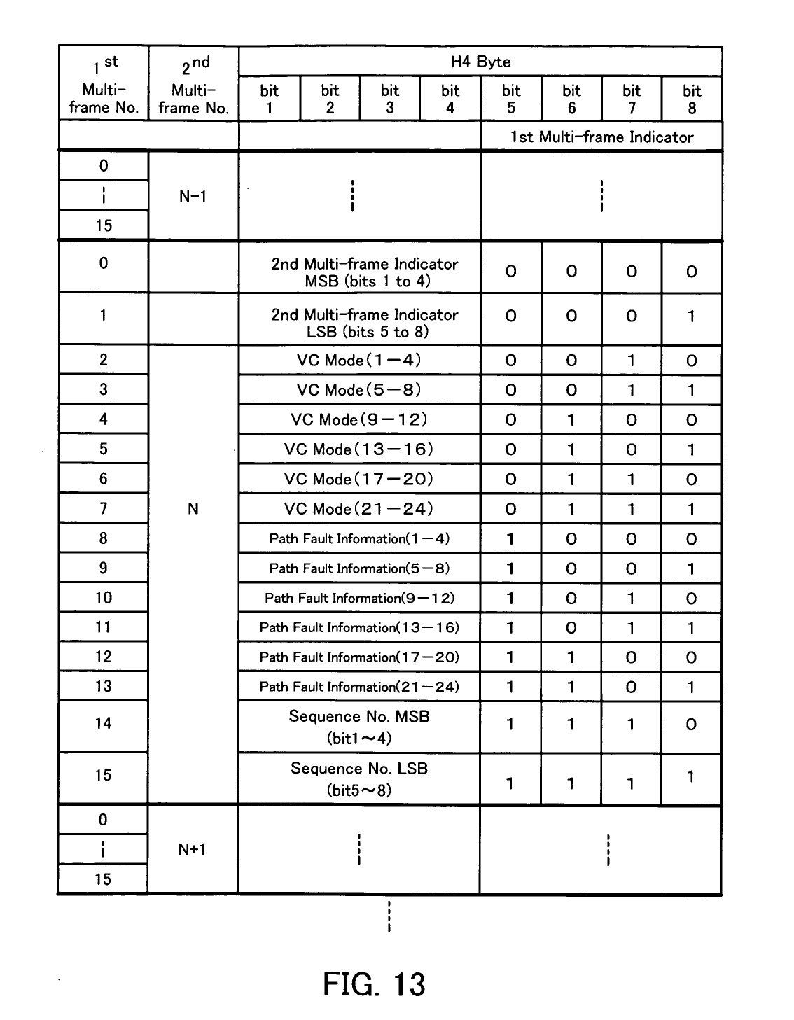

The coding of H4 byte will be now described with reference to FIG. 13. Using a multi-frame format, H4 byte sets 1^{st} multi-frame numbers and 2^{nd} multi-frame numbers.

Bits 5 to 8 of H4 byte are used for the 1^{st} multi-frame numbers. Also, bits 1 to 4 of the 1^{st} multi-frame number “0” are used for the most significant four bits (MSB) of the 2^{nd} multi-frame number, and bits 1 to 4 of the lt multi-frame number “1” are used for the least significant four bits (LSB) of the 2^{nd} multi-frame number.

By using the multi-frame format, it is possible to show information about a maximum of 4096 (=16×256) frames, where “16” is the number of 1^{st} multi-frame numbers “0” through “15” and “256” is the number of 2^{nd} multi-frame numbers “0” through “255.”

Also, in H4 byte, bits 1 to 4 of the 1^{st} multi-frame numbers “2” to “7” are used as an area for holding the VC mode information (VC mode of ch1 to ch24 is held by six regions to each of which four channels are allocated), and bits 1 to 4 of the 1^{st} multi-frame numbers “8” to “13” are used as an area for holding the path fault information (path fault information of ch1 to ch24 is held by six regions to each of which four channels are allocated). Further, bits 1 to 4 of the 1^{st} multi-frame number “14” are used for the most significant four bits (MSB) of the sequence number, and bits 1 to 4 of the 1^{st} multi-frame number “15” are used for the least significant four bits (LSB) of the sequence number.

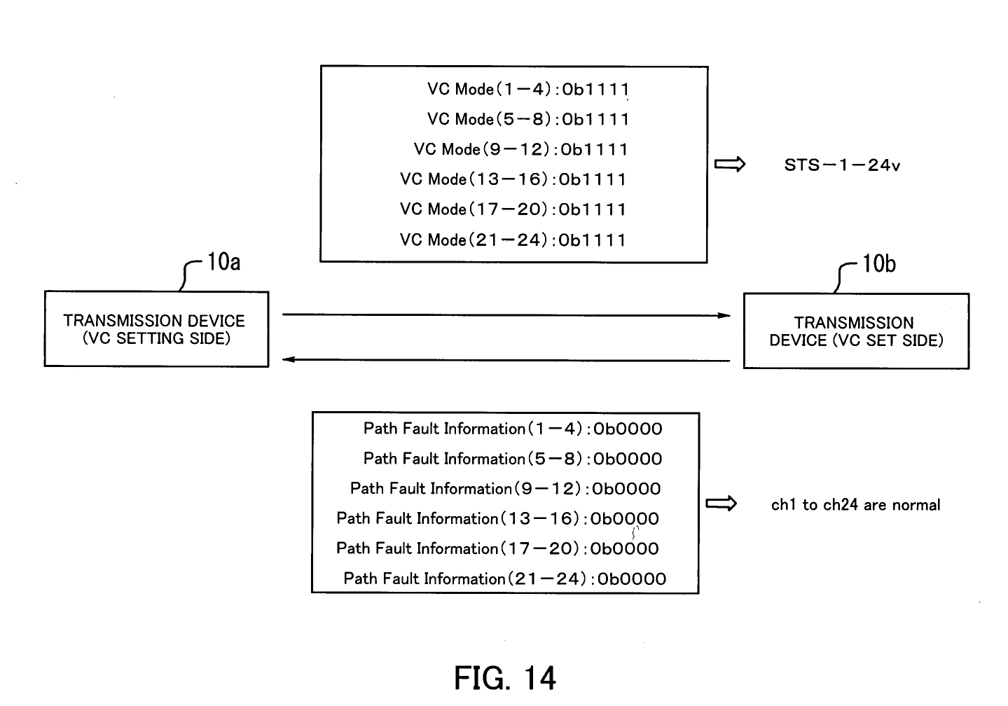

The flow of the VC mode and path fault information will be now described with reference to bit arrangements. FIG. 14 is a conceptual diagram showing the flow of the VC mode and path fault information during normal transmission.

The individual bits of the VC mode correspond to the respective channels, wherein “1” indicates that the corresponding channel is established and “0” indicates that the corresponding channel is not established. For example, in the case of “VC mode (1 to 4): Ob1101” (“Ob” indicates that the notation is binary), the four digits from the leftmost “1” to the rightmost “1” correspond to ch1 to ch4, respectively, showing that ch1, ch2 and ch4 are established while ch3 is not established.

Also, the individual bits of the path fault information correspond to the respective channels, wherein “0” indicates that the corresponding channel is normal and “1” indicates that the corresponding channel is anomalous. In the case of “path fault information (1 to 4): Ob1000,” for example, the four digits from the leftmost “1” to the rightmost “0” correspond to ch1 to ch4, respectively, showing that ch1 is anomalous while ch2 to ch4 are normal.

FIG. 14 illustrates the case where STS-1-24v transmission is carried out between transmission devices 10a and 10b. Using the H4 byte area explained above with reference to FIG. 13, the transmission device 10a sets “1” for all VC mode bits associated with the 24 channels, to notify the transmission device 10b of the VC mode.

In this instance, there is no path fault occurring, and accordingly, the transmission device 10b sets “0” for all path fault information bits associated with the 24 channels by using the H4 byte area explained above with reference to FIG. 13, to send the path fault information to the transmission device 10a.

For the specific patterns, the transmission device 10a sets “AA,” for example, with respect to all channels ch1 to ch24 by using C2 byte of the POH, and the transmission device 10b receives “AA” set with respect to each of the 24 channels.

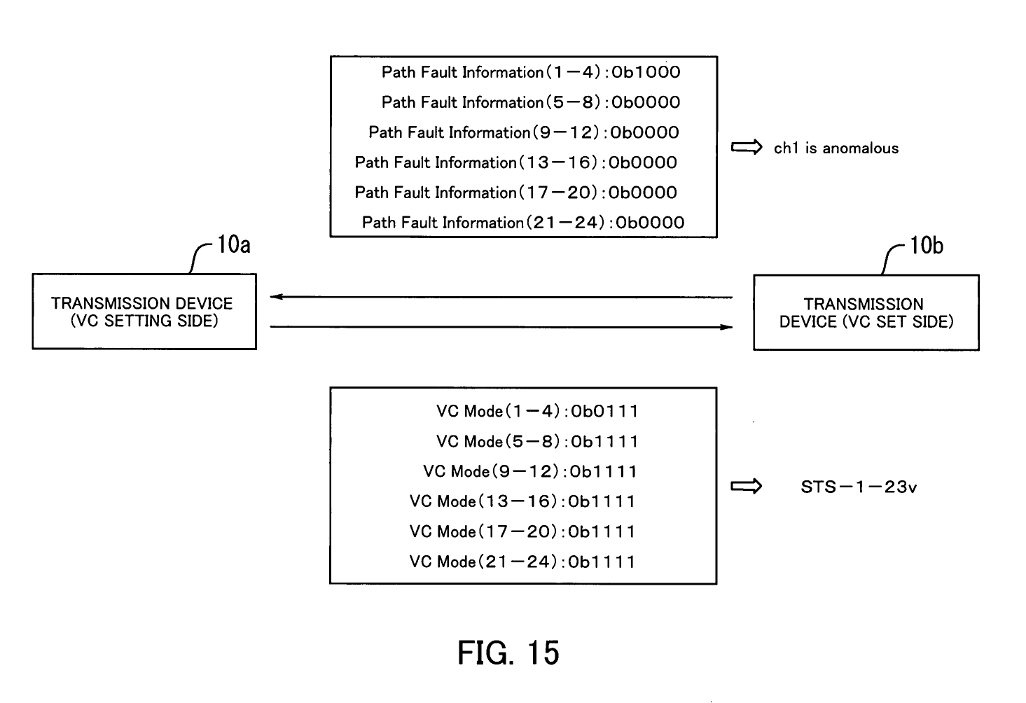

FIG. 15 is a conceptual diagram showing the flow of a newly set VC mode and path fault information after the occurrence of a path fault during transmission. The figure illustrates the case where, at first, STS-1-24v transmission is performed between the transmission devices 10a and 10b, a path fault occurs thereafter in ch1, and thus the transmission device 10b sends a notification of the path fault to the transmission device 10a, which then instructs the transmission device 10b to change the VC mode.

On detecting the occurrence of the path fault in ch1, the transmission device 10b sets “1” for the bit associated with ch1 and “0” for the bits associated with the remaining channels ch2 to ch24, by using the H4 byte area explained above with reference to FIG. 13, to send the path fault information to the transmission device 10a.

The transmission device 10a judges from the received path fault information that a path fault has occurred in ch1, and thus changes the VC mode from STS-1-24v to STS-1-23v. Then, using the H4 byte area explained above with reference to FIG. 13, the transmission device 10a sets “0” for the bit associated with ch1 and “1” for the bits associated with the remaining channels ch2 to ch24, to send VC mode (STS-1-23v) information to the transmission device 10b.

As for the specific patterns, the transmission device 10a sets “AA,” for example, with respect to all channels ch1 to ch24 by using C2 byte of the POH, while the transmission device 10b receives a pattern different from “AA” (e.g., “A9”) with respect to ch1 and “AA” with respect to the other channels ch2 to ch24.

In conventional systems, when setting VC (and also when changing VC), such setting operation must be manually carried out with respect to each transmission device. According to the present invention, as described above, VC has only to be set in one transmission device, and this permits the VC mode to be automatically set in the associated remote device, thus making it possible to improve the operation efficiency and convenience.

Also, even in the case where a channel constituting the VC becomes unusable due to a transmission path fault, the fault can be quickly detected and a new VC mode excluding the faulty channel can be automatically set to enable continued communication, whereby the quality and reliability of communication can be enhanced.

In the foregoing, explanation is directed mainly to VCs constituted by a plurality of STS-1 paths, but the VC may alternatively be constituted by STS-3c or other STS paths than STS-1 paths. Also, the foregoing description is directed to VC in SONET, but the functions of the present invention can be equally applied to VC in SDH.

As described above, the transmission system of the present invention is configured such that the VC mode is set in the VC transmitting and receiving devices through exchange of the VC mode, and that path connection is monitored on the basis of the specific pattern. This not only permits the VC mode to be automatically and flexibly set at a path terminating point but also enables path monitoring, making it possible to improve the convenience as well as the communication quality.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A transmission system for carrying out transmission control for VC in which bandwidth is handled as a set of virtual signal units, comprising:
a VC transmitting device including a transmit-side VC mode setting unit for setting a VC mode of the VC transmitting device in accordance with one of upper-level setting and path fault information, a transmit-side signal control unit for controlling signals of the VC transmitting device in the VC mode, a path monitoring/setting unit for generating a specific pattern for monitoring path connection, and a first signal transmitting/receiving unit for transmitting, to an associated remote device, a signal in which the set VC mode and the specific pattern are inserted, and receiving the path fault information from the remote device; and
a VC receiving device including a second signal transmitting/receiving unit for detecting the VC mode and the specific pattern from the received signal and transmitting, to the associated remote device, a signal in which generated path fault information is inserted, a receive-side VC mode setting unit for setting a VC mode of the VC receiving device in accordance with the detected VC mode, a receive-side signal control unit for controlling signals of the VC receiving device in the VC mode, and a path monitoring/determination unit for determining based on the received specific pattern whether the path connection is normal or not, and generating the path fault information indicative of a determination result.

2. The transmission system according to claim 1, wherein the first signal transmitting/receiving unit inserts the VC mode into H4 byte of path overhead.

3. The transmission system according to claim 1, wherein the first signal transmitting/receiving unit inserts the specific pattern into C2 byte of path overhead.

4. The transmission system according to claim 1, wherein the path monitoring/determination unit judges that a substantial path fault has occurred if an error in the specific pattern is continuously detected for over a preset number of consecutive frames.

5. The transmission system according to claim 1, wherein the second signal transmitting/receiving unit inserts the path fault information into H4 byte of path overhead.

6. The transmission system according to claim 1, wherein, when a path fault is detected from the path fault information, the transmit-side VC mode setting unit resets the VC mode to a new one excluding a faulty channel, and the receive-side VC mode setting unit detects and sets the new VC mode to permit communication to be continued despite the path fault.

7. A transmission device for carrying out transmission control for VC in which bandwidth is handled as a set of virtual signal units, comprising:
a VC mode setting unit for setting a VC mode in accordance with one of upper-level setting and path fault information when operating as a VC mode setting side to transmit the VC mode, and for setting a VC mode in accordance with a VC mode detected from a received signal when operating as a VC mode set side to receive the VC mode;
a signal control unit for controlling signals in the VC mode set by the VC mode setting unit;
a path monitoring/setting unit for generating a specific pattern for monitoring path connection;
a signal transmitting unit for transmitting, to an associated remote device, a signal in which the VC mode, the specific pattern and path fault information are inserted;
a signal receiving unit for detecting a VC mode, a specific pattern and path fault information from the received signal; and
a path monitoring/determination unit for determining based on the received specific pattern whether the path connection is normal or not, and generating the path fault information indicative of a determination result.

8. The transmission device according to claim 7, wherein the signal transmitting unit inserts the VC mode into H4 byte of path overhead.

9. The transmission device according to claim 7, wherein the signal transmitting unit inserts the specific pattern into C2 byte of path overhead.

10. The transmission device according to claim 7, wherein the path monitoring/determination unit judges that a substantial path fault has occurred if an error in the specific pattern is continuously detected for over a preset number of consecutive frames.

11. The transmission device according to claim 7, wherein the signal transmitting unit inserts the path fault information into H4 byte of path overhead.

12. The transmission device according to claim 7, wherein, when a path fault is detected from the path fault information, the VC mode setting unit resets the VC mode to a new one excluding a faulty channel if operating as the VC mode setting side, and detects and sets the new VC mode if operating as the VC mode set side, to permit communication to be continued despite the path fault.

13. A transmission node interconnecting a SONET/SDH network and a LAN, for carrying out transmission control for VC in which bandwidth is handled as a set of virtual signal units, comprising:
a LAN interface unit including a VC mode setting unit for setting a VC mode in accordance with one of upper-level setting and path fault information when operating as a VC mode setting side to transmit the VC mode, and for setting a VC mode in accordance with a VC mode detected from a received signal when operating as a VC mode set side to receive the VC mode, a signal control unit for controlling signals in the VC mode set by the VC mode setting unit, a path monitoring/setting unit for generating a specific pattern for monitoring path connection, a signal transmitting unit for transmitting, to an associated remote node, a signal in which the VC mode, the specific pattern and path fault information are inserted, a signal receiving unit for detecting a VC mode, a specific pattern and path fault information from the received signal, a path monitoring/determination unit for determining based on the received specific pattern whether the path connection is normal or not, and generating the path fault information indicative of a determination result, a switch interface for controlling interfacing with a switching process of the SONET/SDH network side, and a LAN interface for controlling interfacing with the LAN of subscriber side;
a switching unit for switching a SONET/SDH signal; and
a network interface unit for controlling interfacing with the SONET/SDH network.

14. A LAN interface unit for carrying out transmission control for VC in which bandwidth is handled as a set of virtual signal units, comprising:
a VC mode setting unit for setting a VC mode in accordance with one of upper-level setting and path fault information when operating as a VC mode setting side to transmit the VC mode, and for setting a VC mode in accordance with a VC mode detected from a received signal when operating as a VC mode set side to receive the VC mode;
a signal control unit for controlling signals in the VC mode set by the VC mode setting unit;
a path monitoring/setting unit for generating a specific pattern for monitoring path connection;
a signal transmitting unit for transmitting, to an associated remote device, a signal in which the VC mode, the specific pattern and path fault information are inserted;
a signal receiving unit for detecting a VC mode, a specific pattern and path fault information from the received signal;
a path monitoring/determination unit for determining based on the received specific pattern whether the path connection is normal or not, and generating the path fault information indicative of a determination result;
a switch interface for controlling interfacing with a switching process of a SONET/SDH network side; and
a LAN interface for controlling interfacing with a LAN of subscriber side.

15. A VC transmission method for carrying out transmission control for VC in which bandwidth is handled as a set of virtual signal units, comprising the steps of:
transmitting a current VC mode from a transmitting side to a receiving side;
setting the received VC mode at the receiving side;
monitoring, at the receiving side, a path of the current VC mode to determine whether connection of the path is normal or not, and notifying the transmitting side of a monitoring result; and
changing, at the transmitting side, the VC mode to a new VC mode excluding a faulty channel if the faulty channel is detected from the monitoring result, and notifying the receiving side of the new VC mode to thereby continue communication in the new VC mode.
